(19) United States
(12) Patent Application Publication
(10) Pub. No.: US 2021/0340936 A1
(43) Pub. Date: Nov. 4, 2021

(54) FUEL OXYGEN CONVERSION UNIT WITH MAKEUP GAS FROM ACCESSORY GEARBOX

(71) Applicant: General Electric Company, Schenectady, NY (US)

(72) Inventors: Ethan Patrick O'Connor, Hamilton, OH (US); Christian Xavier Stevenson, Blanchester, OH (US); Brandon Wayne Miller, Liberty Township, OH (US)

(21) Appl. No.: 16/864,333

(22) Filed: May 1, 2020

(51) Int. Cl. F02M 27/02; F02C 7/22; B01D 3/34; B01D 53/86

(52) U.S. Cl. CPC F02M 27/02; F02C 7/22; B01D 3/343; B01D 2257/104; F05D 2220/323; F05D 2270/07; B01D 53/8671

(57) ABSTRACT

A fuel oxygen reduction unit for an engine is provided. The fuel oxygen reduction unit includes a contactor including a fuel inlet that receives an inlet fuel flow and a stripping gas inlet that receives an inlet stripping gas flow, the contactor configured to form a fuel/gas mixture; a separator that receives the fuel/gas mixture, the fuel oxygen reduction unit defining a circulation gas flowpath from the separator to the contactor; and a stripping gas source selectively in fluid communication with the circulation gas flowpath for selectively introducing a stripping gas from the stripping gas source to the circulation gas flowpath, wherein the stripping gas source is an accessory gearbox.

### FIELD OF THE INVENTION

The present subject matter relates generally to a fuel oxygen reduction unit for an engine and a method of operating the same.

### BACKGROUND OF THE INVENTION

Typical aircraft propulsion systems include one or more gas turbine engines. The gas turbine engines generally include a turbomachine, the turbomachine including, in serial flow order, a compressor section, a combustion section, a turbine section, and an exhaust section. In operation, air is provided to an inlet of the compressor section where one or more axial compressors progressively compress the air until it reaches the combustion section. Fuel is mixed with the compressed air and burned within the combustion section to provide combustion gases. The combustion gases are routed from the combustion section to the turbine section. The flow of combustion gasses through the turbine section drives the turbine section and is then routed through the exhaust section, e.g., to atmosphere.

Certain operations and systems of the gas turbine engines and aircraft may generate a relatively large amount of heat. Fuel has been determined to be an efficient heat sink to receive at least some of such heat during operations due at least in part to its heat capacity and an increased efficiency in combustion operations that may result from combusting higher temperature fuel.

However, heating the fuel up without properly conditioning the fuel may cause the fuel to “coke,” or form solid particles that may clog up certain components of the fuel system, such as the fuel nozzles. Reducing an amount of oxygen in the fuel may effectively reduce the likelihood that the fuel will coke beyond an unacceptable amount.

### BRIEF DESCRIPTION OF THE INVENTION

Aspects and advantages of the invention will be set forth in part in the following description, or may be obvious from the description, or may be learned through practice of the invention.

In one exemplary embodiment of the present disclosure, a fuel oxygen reduction unit for an engine is provided. The fuel oxygen reduction unit includes a fuel oxygen reduction unit defining a stripping gas flowpath and comprising an inlet fuel line and an outlet fuel line, the fuel oxygen reduction unit comprising: an oxygen transfer assembly for reducing an amount of oxygen in an inlet fuel flow through the inlet fuel line using a stripping gas flow through the stripping gas flowpath; and a stripping gas source selectively in fluid communication with the stripping gas flowpath for selectively introducing a stripping gas from the stripping gas source to the stripping gas flowpath, wherein the stripping gas source is an accessory gearbox.

In certain exemplary embodiments the oxygen transfer assembly comprises: a contactor including a fuel inlet that receives the inlet fuel flow and a stripping gas inlet that receives an inlet stripping gas flow from the stripping gas flowpath, the contactor configured to form a fuel/gas mixture; and a separator that receives the fuel/gas mixture, the fuel oxygen reduction unit defining a circulation gas flowpath from the separator to the contactor.

In certain exemplary embodiments the fuel oxygen reduction unit includes a variable flow valve downstream of the accessory gearbox and upstream of the contactor, wherein the stripping gas from the accessory gearbox is in airflow communication with the circulation gas flowpath via the variable flow valve.

In certain exemplary embodiments the stripping gas comprises accessory gearbox air.

In certain exemplary embodiments the fuel oxygen reduction unit includes a pump downstream of the accessory gearbox and upstream of the variable flow valve, wherein the pump increases a pressure of the stripping gas flowing to the circulation gas flowpath.

In certain exemplary embodiments the fuel oxygen reduction unit includes an eductor downstream of the accessory gearbox and upstream of the variable flow valve, wherein the eductor pumps the stripping gas to the circulation gas flowpath.

In certain exemplary embodiments the fuel oxygen reduction unit includes an air/oil separator downstream of the stripping gas source.

In certain exemplary embodiments the fuel oxygen reduction unit includes an isolation valve in airflow communication with the circulation gas flowpath for modulating a gas flow through the circulation gas flowpath to the contactor.

In certain exemplary embodiments the stripping gas flows to the circulation gas flowpath downstream of the separator and upstream of the contactor.

In certain exemplary embodiments the separator includes an inlet in fluid communication with the contactor that receives the fuel/gas mixture, a fuel outlet, and a stripping gas outlet, wherein the separator is configured to separate the fuel/gas mixture into an outlet stripping gas flow and an outlet fuel flow and provide the outlet stripping gas flow to the stripping gas outlet and the outlet fuel flow to the fuel outlet.

In certain exemplary embodiments the fuel oxygen reduction unit includes a catalyst disposed downstream of the separator, the catalyst receives and treats the outlet stripping gas flow, wherein the inlet stripping gas flow exits the catalyst; and a gas boost pump downstream of the separator, wherein the gas boost pump increases a pressure of the inlet stripping gas flow to the contactor.

In another exemplary embodiment of the present disclosure, a fuel oxygen reduction unit for an engine is provided. The fuel oxygen reduction unit includes a contactor; a separator, the fuel oxygen reduction unit defining a circulation gas flowpath from the separator to the contactor; and a stripping gas source selectively in fluid communication with the circulation gas flowpath for selectively introducing a stripping gas from the stripping gas source to the circulation gas flowpath, wherein the stripping gas comprises accessory gearbox air.

In certain exemplary embodiments the fuel oxygen reduction unit includes a variable flow valve downstream of the stripping gas source and upstream of the contactor, wherein the stripping gas from the stripping gas source is in airflow communication with the circulation gas flowpath via the variable flow valve.

In certain exemplary embodiments the stripping gas source is an accessory gearbox, and wherein the stripping gas flows to the circulation gas flowpath downstream of the separator and upstream of the contactor.

In certain exemplary embodiments the fuel oxygen reduction unit includes a pump downstream of the stripping gas source and upstream of the variable flow valve, wherein the pump increases a pressure of the stripping gas flowing to the circulation gas flowpath.

In certain exemplary embodiments the fuel oxygen reduction unit includes an eductor downstream of the stripping gas source and upstream of the variable flow valve, wherein the eductor pumps the stripping gas to the circulation gas flowpath.

In certain exemplary embodiments the fuel oxygen reduction unit includes an air/oil separator downstream of the stripping gas source.

In certain exemplary embodiments the fuel oxygen reduction unit includes an isolation valve in airflow communication with the circulation gas flowpath for modulating a gas flow through the circulation gas flowpath to the contactor.

In certain exemplary embodiments the contactor includes a fuel inlet that receives an inlet fuel flow and a stripping gas inlet that receives an inlet stripping gas flow, the contactor configured to form a fuel/gas mixture.

In certain exemplary embodiments the separator receives the fuel/gas mixture and includes an inlet in fluid communication with the contactor that receives the fuel/gas mixture, a fuel outlet, and a stripping gas outlet, wherein the separator is configured to separate the fuel/gas mixture into an outlet stripping gas flow and an outlet fuel flow and provide the outlet stripping gas flow to the stripping gas outlet and the outlet fuel flow to the fuel outlet.

In certain exemplary embodiments the fuel oxygen reduction unit includes a catalyst disposed downstream of the separator, the catalyst receives and treats the outlet stripping gas flow, wherein the inlet stripping gas flow exits the catalyst; and a gas boost pump downstream of the separator, wherein the gas boost pump increases a pressure of the inlet stripping gas flow to the contactor.

In an exemplary aspect of the present disclosure, a method is provided for operating a fuel delivery system for a gas turbine engine. The method includes receiving an inlet fuel flow in a fuel oxygen reduction unit for reducing an amount of oxygen in the inlet fuel flow using a stripping gas flow through a stripping gas flowpath; and selectively introducing a stripping gas from a stripping gas source to the stripping gas flowpath, wherein the stripping gas source is an accessory gearbox.

These and other features, aspects and advantages of the present invention will become better understood with reference to the following description and appended claims. The accompanying drawings, which are incorporated in and constitute a part of this specification, illustrate embodiments of the invention and, together with the description, serve to explain the principles of the invention.

### BRIEF DESCRIPTION OF THE DRAWINGS

A full and enabling disclosure of the present invention, including the best mode thereof, directed to one of ordinary skill in the art, is set forth in the specification, which makes reference to the appended figures, in which:

FIG. 1 is a schematic, cross-sectional view of a gas turbine engine in accordance with an exemplary embodiment of the present disclosure.

FIG. 2 is a schematic view of a fuel oxygen reduction unit in accordance with an exemplary embodiment of the present disclosure.

FIG. 3 is a schematic view of a fuel oxygen reduction unit in accordance with another exemplary embodiment of the present disclosure.

Corresponding reference characters indicate corresponding parts throughout the several views. The exemplifications set out herein illustrate exemplary embodiments of the disclosure, and such exemplifications are not to be construed as limiting the scope of the disclosure in any manner.

### DETAILED DESCRIPTION OF THE INVENTION

Reference will now be made in detail to present embodiments of the invention, one or more examples of which are illustrated in the accompanying drawings. The detailed description uses numerical and letter designations to refer to features in the drawings. Like or similar designations in the drawings and description have been used to refer to like or similar parts of the invention.

The following description is provided to enable those skilled in the art to make and use the described embodiments contemplated for carrying out the invention. Various modifications, equivalents, variations, and alternatives, however, will remain readily apparent to those skilled in the art. Any and all such modifications, variations, equivalents, and alternatives are intended to fall within the spirit and scope of the present invention.

For purposes of the description hereinafter, the terms “upper”, “lower”, “right”, “left”, “vertical”, “horizontal”, “top”, “bottom”, “lateral”, “longitudinal”, and derivatives thereof shall relate to the invention as it is oriented in the drawing figures. However, it is to be understood that the invention may assume various alternative variations, except where expressly specified to the contrary. It is also to be understood that the specific devices illustrated in the attached drawings, and described in the following specification, are simply exemplary embodiments of the invention. Hence, specific dimensions and other physical characteristics related to the embodiments disclosed herein are not to be considered as limiting.

As used herein, the terms “first”, “second”, and “third” may be used interchangeably to distinguish one component from another and are not intended to signify location or importance of the individual components.

The terms “upstream” and “downstream” refer to the relative direction with respect to fluid flow in a fluid pathway. For example, “upstream” refers to the direction from which the fluid flows, and “downstream” refers to the direction to which the fluid flows.

The terms “coupled,” “fixed,” “attached to,” and the like refer to both direct coupling, fixing, or attaching, as well as indirect coupling, fixing, or attaching through one or more intermediate components or features, unless otherwise specified herein.

The singular forms “a”, “an”, and “the” include plural references unless the context clearly dictates otherwise.

Approximating language, as used herein throughout the specification and claims, is applied to modify any quantitative representation that could permissibly vary without resulting in a change in the basic function to which it is related. Accordingly, a value modified by a term or terms, such as “about”, “approximately”, and “substantially”, are not to be limited to the precise value specified. In at least some instances, the approximating language may correspond to the precision of an instrument for measuring the value, or the precision of the methods or machines for constructing or manufacturing the components and/or systems. For example, the approximating language may refer to being within a 10 percent margin.

Here and throughout the specification and claims, range limitations are combined and interchanged, such ranges are identified and include all the sub-ranges contained therein unless context or language indicates otherwise. For example, all ranges disclosed herein are inclusive of the endpoints, and the endpoints are independently combinable with each other.

In a fuel oxygen reduction unit of the present disclosure, the fuel oxygen reduction unit includes a makeup or stripping gas source fluidly connected to a circulation gas flowpath. The makeup gas source is an accessory gearbox and the stripping gas is accessory gearbox air. The makeup or stripping gas source is selectively in fluid communication with the circulation gas flowpath for selectively introducing a stripping gas from the stripping gas source to the circulation gas flowpath.

By utilizing a makeup or stripping gas source that is accessory gearbox air from an accessory gearbox, the system of the present disclosure eliminates weight and the routing of additional components, and also provides a source of makeup gas in close proximity to the fuel oxygen reduction unit.

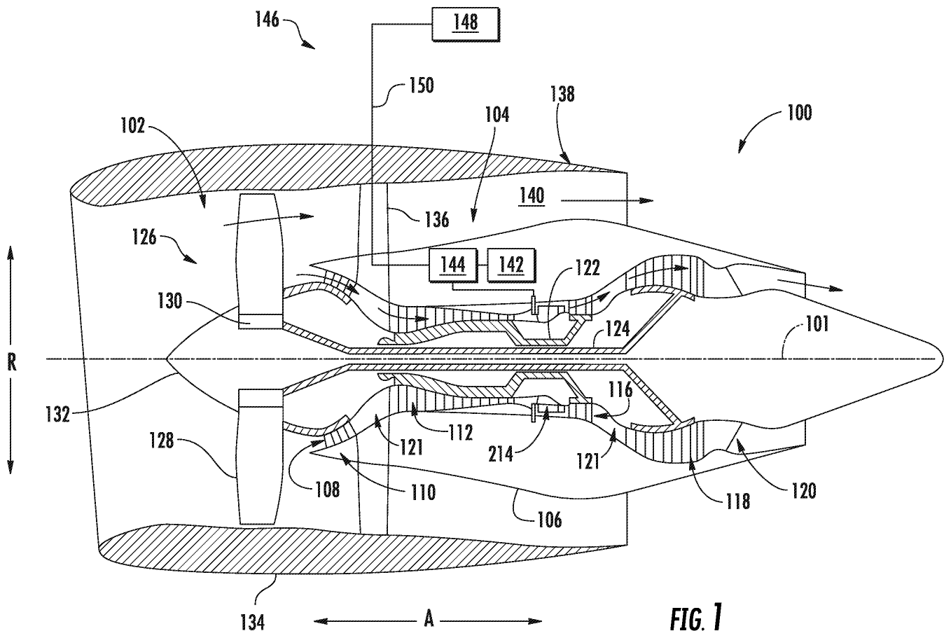

Referring now to the drawings, wherein identical numerals indicate the same elements throughout the figures, FIG. 1 provides a schematic, cross-sectional view of an engine in accordance with an exemplary embodiment of the present disclosure. The engine may be incorporated into a vehicle. For example, the engine may be an aeronautical engine incorporated into an aircraft. Alternatively, however, the engine may be any other suitable type of engine for any other suitable aircraft.

For the embodiment depicted, the engine is configured as a high bypass turbofan engine 100. As shown in FIG. 1, the turbofan engine 100 defines an axial direction A (extending parallel to a longitudinal centerline or axis 101 provided for reference), a radial direction R, and a circumferential direction (extending about the axial direction A; not depicted in FIG. 1). In general, the turbofan 100 includes a fan section 102 and a turbomachine 104 disposed downstream from the fan section 102.

The exemplary turbomachine 104 depicted generally includes a substantially tubular outer casing 106 that defines an annular inlet 108. The outer casing 106 encases, in serial flow relationship, a compressor section including a booster or low pressure (LP) compressor 110 and a high pressure (HP) compressor 112; a combustion section 114; a turbine section including a high pressure (HP) turbine 116 and a low pressure (LP) turbine 118; and a jet exhaust nozzle section 120. The compressor section, combustion section 114, and turbine section together define at least in part a core air flowpath 121 extending from the annular inlet 108 to the jet nozzle exhaust section 120. The turbofan engine further includes one or more drive shafts. More specifically, the turbofan engine includes a high pressure (HP) shaft or spool 122 drivingly connecting the HP turbine 116 to the HP compressor 112, and a low pressure (LP) shaft or spool 124 drivingly connecting the LP turbine 118 to the LP compressor 110.

For the embodiment depicted, the fan section 102 includes a fan 126 having a plurality of fan blades 128 coupled to a disk 130 in a spaced apart manner. The fan blades 128 and disk 130 are together rotatable about the longitudinal axis 101 by the LP shaft 124. The disk 130 is covered by rotatable front hub 132 aerodynamically contoured to promote an airflow through the plurality of fan blades 128. Further, an annular fan casing or outer nacelle 134 is provided, circumferentially surrounding the fan 126 and/or at least a portion of the turbomachine 104. The nacelle 134 is supported relative to the turbomachine 104 by a plurality of circumferentially-spaced outlet guide vanes 136. A downstream section 138 of the nacelle 134 extends over an outer portion of the turbomachine 104 so as to define a bypass airflow passage 140 therebetween.

Referring still to FIG. 1, the turbofan engine 100 additionally includes an accessory gearbox 142, a fuel oxygen reduction unit 144, and a fuel delivery system 146. Although for the embodiment shown, the accessory gearbox 142 is located within the cowling/outer casing 106 of the turbomachine 104, it is contemplated that the accessory gearbox 142 may be located within other portions of the turbomachine 104. For example, the accessory gearbox 142 may be located within portions of the fan 126 of the turbomachine 104, e.g., a fan cowl or other portion of the fan 126. In such a configuration, the accessory gearbox 142 is not mounted on the core, may still be driven by the HP shaft 122, and does not readily have access to the engine bleeds. Additionally, it will be appreciated that, although not depicted schematically in FIG. 1, the accessory gearbox 142 may be mechanically coupled to, and rotatable with, one or more shafts or spools of the turbomachine 104. For example, in at least certain exemplary embodiments, the accessory gearbox 142 may be mechanically coupled to, and rotatable with, the HP shaft 122. Further, for the embodiment shown, the fuel oxygen reduction unit 144 is coupled to, or otherwise rotatable with, the accessory gearbox 142, although in other embodiments the fuel oxygen conversion unit 144 may use other, or additional sources, of rotary power such as an electric motor. In such a manner, it will be appreciated that the exemplary fuel oxygen reduction unit 144 is driven by the accessory gearbox 142. Notably, as used herein, the term “fuel oxygen conversion or reduction” generally means a device capable of reducing a free oxygen content of the fuel.

Moreover, the fuel delivery system 146 generally includes a fuel source 148, such as a fuel tank, and one or more fuel lines 150. The one or more fuel lines 150 provide a fuel flow through the fuel delivery system 146 to the combustion section 114 of the turbomachine 104 of the turbofan engine 100.

It will be appreciated, however, that the exemplary turbofan engine 100 depicted in FIG. 1 is provided by way of example only. In other exemplary embodiments, any other suitable engine may be utilized with aspects of the present disclosure. For example, in other embodiments, the engine may be any other suitable gas turbine engine, such as a turboshaft engine, turboprop engine, turbojet engine, etc. In such a manner, it will further be appreciated that in other embodiments the gas turbine engine may have any other suitable configuration, such as any other suitable number or arrangement of shafts, compressors, turbines, fans, etc. Further, although the exemplary gas turbine engine depicted in FIG. 1 is shown schematically as a direct drive, fixed-pitch turbofan engine 100, in other embodiments, a gas turbine engine of the present disclosure may be a geared gas turbine engine (i.e., including a gearbox between the fan 126 and shaft driving the fan, such as the LP shaft 124), may be a variable pitch gas turbine engine (i.e., including a fan 126 having a plurality of fan blades 128 rotatable about their respective pitch axes), etc. Further, although not depicted herein, in other embodiments the gas turbine engine may be any other suitable type of gas turbine engine, such as an industrial gas turbine engine incorporated into a power generation system, a nautical gas turbine engine, etc. Further, still, in alternative embodiments, aspects of the present disclosure may be incorporated into, or otherwise utilized with, any other type of engine, such as reciprocating engines.

Moreover, it will be appreciated that although for the embodiment depicted, the turbofan engine 100 includes the fuel oxygen reduction unit 144 positioned within the turbomachine 104, i.e., within the casing 106 of the turbomachine 104, in other embodiments, the fuel oxygen reduction unit 144 may be positioned at any other suitable location. For example, in other embodiments, the fuel oxygen reduction unit 144 may instead be positioned remote from the turbofan engine 100, such as proximate to, or within, the tank of the fuel delivery system 146. Additionally, in other embodiments, the fuel oxygen reduction unit 144 may additionally or alternatively be driven by other suitable power sources such as an electric motor, a hydraulic motor, or an independent mechanical coupling to the HP or LP shaft, etc.

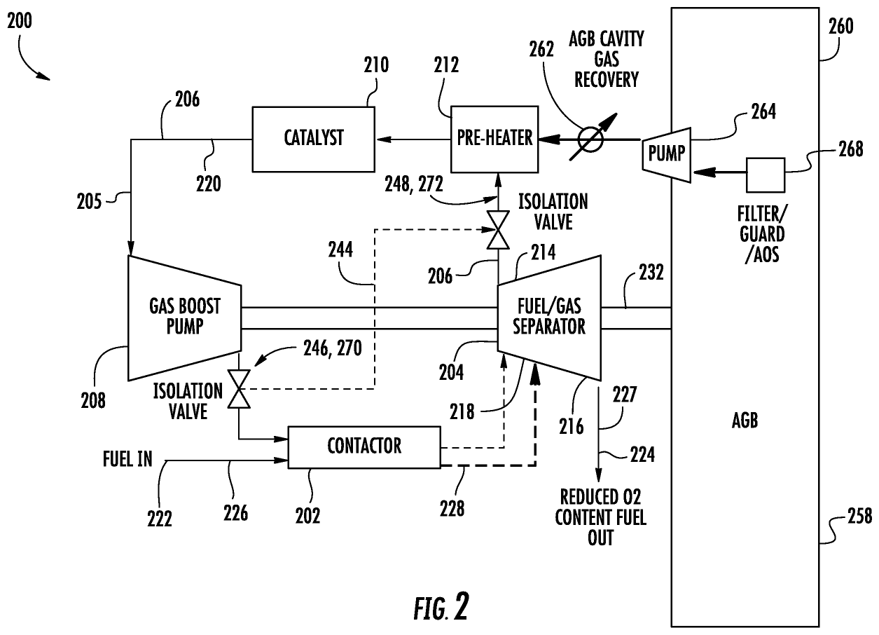

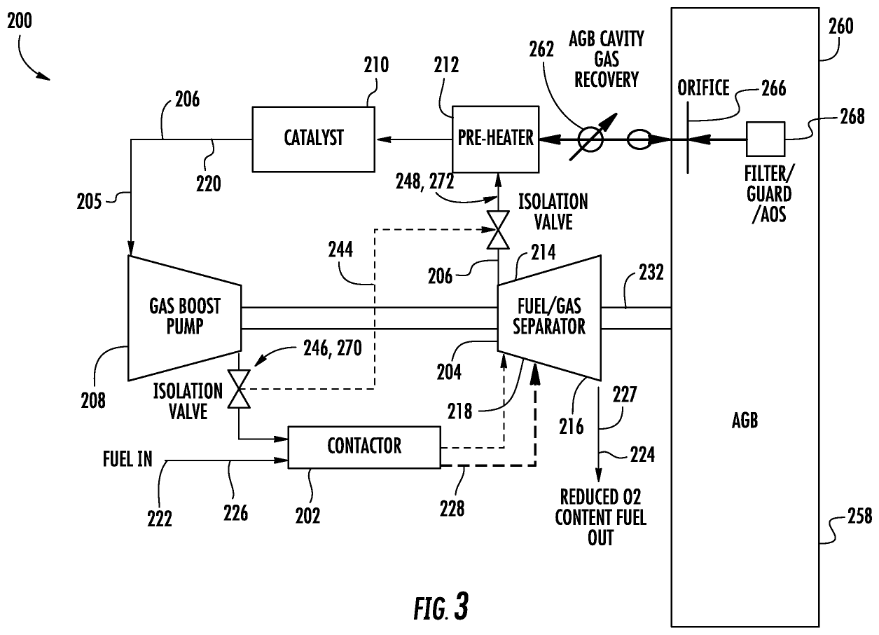

Referring now to FIGS. 2 and 3, schematic drawings of a fuel oxygen reduction unit 200 for a gas turbine engine in accordance with exemplary embodiments of the present disclosure is provided. In at least certain exemplary embodiments, the exemplary fuel oxygen reduction unit 200 depicted may be incorporated into, e.g., the exemplary engine 100 described above with reference to FIG. 1 (e.g., may be the fuel oxygen reduction unit 144 depicted in FIG. 1 and described above).

As will be appreciated from the discussion herein, in an exemplary embodiment, the exemplary fuel oxygen reduction unit 200 of FIGS. 2 and 3 generally includes a contactor 202, a separator 204, a pre-heater 212, a catalyst 210, a gas boost pump 208, and a stripping gas source 260. Moreover, the exemplary fuel oxygen reduction unit 200 generally defines a circulation gas flowpath 206 from the separator 204 to the contactor 202, with, for the embodiment depicted in FIG. 2, the pre-heater 212, the catalyst 210, and the gas boost pump 208 being positioned within or otherwise fluidly connected to the circulation gas flowpath 206.

In exemplary embodiments, the contactor 202 may be configured in any suitable manner to substantially mix a received gas and liquid flow. For example, the contactor 202 may, in certain embodiments, be a mechanically driven contactor (e.g., having paddles for mixing the received flows), or alternatively may be a passive contactor for mixing the received flows using, at least in part, a pressure and/or flowrate of the received flows. For example, a passive contactor may include one or more turbulators, a venturi mixer, etc.

Moreover, the exemplary fuel oxygen reduction unit 200 includes a stripping gas line 205, and more particularly, includes a plurality of stripping gas lines 205, which together at least in part define a circulation gas flowpath 206 extending from the separator 204 to the contactor 202. In certain exemplary embodiments, the circulation gas flowpath 206 may be formed of any combination of one or more conduits, tubes, pipes, etc. in addition to the plurality stripping gas lines 205 and structures or components within the circulation gas flowpath 206.

It will be appreciated that the fuel oxygen reduction unit 200 generally provides for a flow of stripping gas 220 through the plurality of stripping gas lines 205 and the stripping gas flowpath 206 during operation. It will be appreciated that the term “stripping gas” is used herein as a term of convenience to refer to a gas generally capable of performing the functions described herein. The stripping gas 220 flowing through the stripping gas flowpath/circulation gas flowpath 206 may be an actual stripping gas functioning to strip oxygen from the fuel within the contactor, or alternatively may be a sparging gas bubbled through a liquid fuel to reduce an oxygen content of such fuel. For example, as will be discussed in greater detail below, the stripping gas 220 may be an inert gas, such as Nitrogen or Carbon Dioxide (CO2), a gas mixture made up of at least 50% by mass inert gas, or some other gas or gas mixture having a relatively low oxygen content.

Further, for the exemplary oxygen reduction unit depicted in FIG. 2, the fuel oxygen reduction unit 200 further includes a gas boost pump 208, a catalyst 210, and a pre-heater 212. For the embodiment shown, the gas boost pump 208, the catalyst 210, and the pre-heater 212 are each arranged within the circulation gas flowpath 206 in series flow. Additionally, the gas boost pump 208 is configured as a rotary gas pump mechanically coupled to, and driven by the fuel gas separator 204. In such a manner, the gas boost pump 208 is rotatable with fuel gas separator 204. However, in other embodiments, the gas boost pump 208 may be configured in any other suitable manner. For example, in other embodiments, the gas boost pump 208 may be mechanically disconnected from, and independently rotatable relative to, the fuel gas separator 204. For example, in certain embodiments, the gas boost pump 208 and/or separator 204 may be independently coupled to an accessory gearbox, or may be an electric pump electrically coupled to a suitable electrical power source, such as a permanent magnet alternator (PMA) that may also serve to provide power to a full authority digital control engine controller (FADEC). In an embodiment where the gas boost pump 208 is coupled to a power source independent of the separator 204, the gas boost pump 208 may rotate at a different rotational speed than the fuel gas separator 204.

In an exemplary embodiment using a permanent magnet alternator (PMA) as a power source for a gas boost pump 208 and/or separator 204, a full authority digital control engine controller (FADEC) is powered by a dedicated PMA, which is in turn rotated by/driven by an accessory gearbox of a gas turbine engine. The PMA is therefore sized to be capable of providing a sufficient amount of electrical power to the FADEC during substantially all operating conditions, including relatively low-speed operating conditions, such as start-up and idle. As the engine comes up to speed, however, the PMA may generate an increased amount electric power, while an amount of electric power required to operate the FADEC may remain relatively constant. Accordingly, as the engine comes up to speed the PMA may generate an amount of excess electric power that may need to be dissipated through an electrical sink.

The inventors of the present disclosure have found that a power consumption need for a fuel oxygen reduction unit may complement the power generation of the PMA. More specifically, the fuel oxygen reduction unit may need a relatively low amount of electric power during low rotational speeds of the gas turbine engine (when the PMA is not creating much excess electrical power), and a relatively high amount of electric power during high rotational speeds of the gas turbine engine (when the PMA is creating excess electrical power). Accordingly, by using the PMA to power the fuel oxygen reduction unit, the electrical power generated by the PMA may be more efficiently utilized.

It will be appreciated, however, that such a configuration is by way of example only, and in other embodiments the FADEC may be any other suitable engine controller, the PMA may be any other suitable electric machine, etc. Accordingly, in certain embodiments, an engine system is provided for an aircraft having an engine and an engine controller. The engine system includes an electric machine configured to be in electrical communication with the engine controller for powering the engine controller; and a fuel oxygen reduction unit defining a liquid fuel flowpath and a stripping gas flowpath and configured to transfer an oxygen content of a fuel flow through the liquid fuel flowpath to a stripping gas flow through the stripping gas flowpath, the fuel oxygen reduction unit also in electrical communication with the electric machine such that the electric machine powers at least in part the fuel oxygen reduction unit.

Referring to FIG. 2, in an exemplary embodiment, the separator 204 generally includes a stripping gas outlet 214, a fuel outlet 216, and an inlet 218. It will also be appreciated that the exemplary fuel oxygen reduction unit 200 depicted is operable with a fuel delivery system 146, such as a fuel delivery system 146 of the gas turbine engine including the fuel oxygen reduction unit 200 (see, e.g., FIG. 1). The exemplary fuel delivery system 146 generally includes a plurality of fuel lines, and in particular, an inlet fuel line 222 and an outlet fuel line 224. The inlet fuel line 222 is fluidly connected to the contactor 202 for providing a flow of liquid fuel or inlet fuel flow 226 to the contactor 202 (e.g., from a fuel source, such as a fuel tank) and the outlet fuel line 224 is fluidly connected to the fuel outlet 216 of the separator 204 for receiving a flow of deoxygenated liquid fuel or outlet fuel flow 227.

Moreover, during typical operations, a flow of stripping gas 220 flows through the circulation gas flowpath 206 from the stripping gas outlet 214 of the separator 204 to the contactor 202. More specifically, during typical operations, stripping gas 220 flows from the stripping gas outlet 214 of the separator 204, through the pre-heater 212 (configured to add heat energy to the gas flowing therethrough), through the catalyst 210, and to/through the gas boost pump 208, wherein a pressure of the stripping gas 220 is increased to provide for the flow of the stripping gas 220 through the circulation gas flowpath 206. The relatively high pressure stripping gas 220 (i.e., relative to a pressure upstream of the boost pump 208 and the fuel entering the contactor 202) is then provided to the contactor 202, wherein the stripping gas 220 is mixed with the flow of inlet fuel 226 from the inlet fuel line 222 to generate a fuel gas mixture 228. The fuel gas mixture 228 generated within the contactor 202 is provided to the inlet 218 of the separator 204.

Generally, it will be appreciated that during operation of the fuel oxygen reduction unit 200, the inlet fuel 226 provided through the inlet fuel line 222 to the contactor 202 may have a relatively high oxygen content. The stripping gas 220 provided to the contactor 202 may have a relatively low oxygen content or other specific chemical structure. Within the contactor 202, the inlet fuel 226 is mixed with the stripping gas 220, resulting in the fuel gas mixture 228. As a result of such mixing a physical exchange may occur whereby at least a portion of the oxygen within the inlet fuel 226 is transferred to the stripping gas 220, such that the fuel component of the mixture 228 has a relatively low oxygen content (as compared to the inlet fuel 226 provided through inlet fuel line 222) and the stripping gas component of the mixture 228 has a relatively high oxygen content (as compared to the inlet stripping gas 220 provided through the circulation gas flowpath 206 to the contactor 202).

Within the separator 204 the relatively high oxygen content stripping gas 220 is then separated from the relatively low oxygen content fuel 226 back into respective flows of an outlet stripping gas 220 and outlet fuel 227.

In one exemplary embodiment, the separator 204 may be a dual separator pump. For example, the separator 204 defines a central axis, radial direction, and a circumferential direction extending about the central axis. Additionally, the separator 204 is configured as a mechanically-driven dual separator pump, or more specifically as a rotary/centrifugal dual separator pump. Accordingly, the separator 204 may include an input shaft 232 and a single-stage separator/pump assembly. The input shaft 232 may be mechanically coupled to the single-stage separator/pump assembly, and the two components are together rotatable about the central axis. Further, the input shaft 232 may be mechanically coupled to, and driven by, e.g., an accessory gearbox 258 (such as the exemplary accessory gearbox 142 of FIG. 1). However, in other embodiments, the input shaft 232 may be mechanically coupled to any other suitable power source, such as an electric motor, PMA, or other electrical power source. As will be appreciated, the single-stage separator/pump assembly may simultaneously separate the mixture 228 into flows of an outlet stripping gas 220 and outlet fuel 227 from the mixture 228 and increase a pressure of the separated outlet fuel 227.

Additionally, an exemplary single-stage separator/pump assembly may include an inner gas filter arranged along the central axis and a plurality of paddles positioned outward of the inner gas filter along the radial direction. During operation, a rotation of the single-stage separator/pump assembly about the central axis, and more specifically, a rotation of the plurality of paddles about the central axis (i.e., in the circumferential direction), may generally force heavier liquid fuel 226 outward along the radial direction and lighter stripping gas 220 inward along the radial direction through the inner gas filter. In such a manner, the outlet fuel 227 may exit through the fuel outlet 216 of the separator 204 and the outlet stripping gas 220 may exit through the gas outlet 214 of the separator 204.

Further, it will be appreciated that with such a configuration, the outlet fuel 227 exiting the separator 204 through the fuel outlet 216 may be at a higher pressure than the inlet fuel 226 provided through inlet fuel line 222, and further higher than the fuel/gas mixture 228 provided through the inlet 218. Such may be due at least in part to the centrifugal force exerted on such liquid fuel 226 and the rotation of the plurality of paddles. Additionally, it will be appreciated that for some embodiments, the liquid fuel outlet 216 is positioned outward of the inlet 218 (i.e., the fuel gas mixture inlet) along the radial direction. Such may also assist with the increasing of the pressure of the outlet fuel 227 provided through the fuel outlet 216 of the separator 204.

For example, it will be appreciated that with such an exemplary embodiment, the separator 204 of the fuel oxygen reduction unit 200 may generate a pressure rise in the fuel flow during operation. As used herein, the term “pressure rise” refers to a net pressure differential between a pressure of the flow of outlet fuel 227 provided to the fuel outlet 216 of the separator 204 (i.e., a “liquid fuel outlet pressure”) and a pressure of the inlet fuel 226 provided through the inlet fuel line 222 to the contactor 202. In at least certain exemplary embodiments, the pressure rise of the liquid fuel 226 may be at least about sixty (60) pounds per square inch (“psi”), such as at least about ninety (90) psi, such as at least about one hundred (100) psi, such as up to about seven hundred and fifty (750) psi. With such a configuration, it will be appreciated that in at least certain exemplary embodiments of the present disclosure, the liquid fuel outlet pressure may be at least about seventy (70) psi during operation. For example, in at least certain exemplary embodiments, the liquid fuel out of pressure may be at least about one hundred (100) psi during operation, such as at least about one hundred and twenty-five (125) psi during operation, such as up to about eight hundred (800) psi during operation. Additional details about these dual functions of the separator 204 will be discussed below with reference to FIG. 7.

Further, it will be appreciated that the outlet fuel 227 provided to the fuel outlet 216, having interacted with the stripping gas 220, may have a relatively low oxygen content, such that a relatively high amount of heat may be added thereto with a reduced risk of the fuel coking (i.e., chemically reacting to form solid particles which may clog up or otherwise damage components within the fuel flow path). For example, in at least certain exemplary aspects, the outlet fuel 227 provided to the fuel outlet 216 may have an oxygen content of less than about five (5) parts per million (“ppm”), such as less than about three (3) ppm, such as less than about two (2) ppm, such as less than about one (1) ppm, such as less than about 0.5 ppm.

Moreover, as will be appreciated, the exemplary fuel oxygen reduction unit 200 depicted recirculates and reuses at least some of, or all of the stripping gas 220 (i.e., the stripping gas 220 operates in a substantially closed loop). However, the stripping gas 220 exiting the separator 204, having interacted with the liquid fuel 226, has a relatively high oxygen content. Accordingly, in order to reuse the stripping gas 220, an oxygen content of the stripping gas 220 from the outlet 214 of the separator 204 needs to be reduced. For the embodiment depicted, and as noted above, the stripping gas 220 flows through the pre-heater 212 and through the catalyst 210 where the oxygen content of the stripping gas 220 is reduced. More specifically, within the catalyst 210 the relatively oxygen-rich stripping gas 220 is reacted to reduce the oxygen content thereof. It will be appreciated that catalyst 210 may be configured in any suitable manner to perform such functions. For example, in certain embodiments, the catalyst 210 may be configured to combust the relatively oxygen-rich stripping gas 220 to reduce an oxygen content thereof. However, in other embodiments, the catalyst 210 may additionally, or alternatively, include geometries of catalytic components through which the relatively oxygen-rich stripping gas 220 flows to reduce an oxygen content thereof. In one or more of these configurations, a byproduct may be produced, such as water. The water, if produced, may be in vapor form and continue as part of the stripping gas 220. Alternatively, the water or other byproduct, if produced, may be ducted away from the catalyst 210 (duct not depicted in the embodiment of FIG. 2). In one or more of these embodiments, the catalyst 210 may be configured to reduce an oxygen content of the stripping gas 220 to less than about five percent (5%) oxygen (O2) by mass, such less than about two (2) percent (3%) oxygen (O2) by mass, such less than about one percent (1%) oxygen (O2) by mass.

The resulting relatively low oxygen content gas is then provided through the remainder of the circulation gas flowpath 206 and back to the contactor 202, such that the cycle may be repeated. In such a manner, it will be appreciated that the stripping gas 220 may be any suitable gas capable of undergoing the chemical transitions described above.

Referring to FIGS. 2 and 3, it will also be appreciated that the exemplary fuel oxygen reduction unit 200 depicted includes a makeup or stripping gas source 260 fluidly connected to the circulation gas flowpath 206. In an exemplary embodiment, the makeup gas source 260 includes, or may entirely be from accessory gearbox 258 and the stripping gas includes, or may entirely be from accessory gearbox air. The makeup or stripping gas source 260 is selectively in fluid communication with the circulation gas flowpath 206 for selectively introducing a stripping gas from the stripping gas source 260 to the circulation gas flowpath 206. Referring to FIGS. 2 and 3, the stripping gas flows to the circulation gas flowpath 206 downstream of the separator 204 and upstream of the contactor 202. It is contemplated that the accessory gearbox air may include accessory gearbox vent air.

For the embodiment depicted, the makeup gas source 260 is in airflow communication with the circulation gas flowpath 206 through a variable flow valve 262, which may be actuatable to supply additional gas to the circulation gas flowpath 206 as needed. Referring to FIG. 2, the variable flow valve 262 is downstream of the accessory gearbox 258 and upstream of the contactor 202. Although not depicted, the fuel oxygen reduction unit 200 may include one or more sensors for determining an airflow volume/flowrate through the circulation gas flowpath 206 to determine an amount of, if any, makeup gas that is needed.

By utilizing a makeup or stripping gas source 260 that is accessory gearbox air from an accessory gearbox 258, the system of the present disclosure eliminates weight and the routing of additional components, and also provides a source of makeup gas in close proximity to the fuel oxygen reduction unit 200.

The makeup or stripping gas source 260 may include different configurations based on the amount of pressure for a particular application.

For example, referring to FIG. 2, in a first exemplary embodiment, the arrangement includes a pump 264 downstream of the accessory gearbox 258 and upstream of the variable flow valve 262. Such a configuration is helpful in lower pressure applications, such as commercial applications, and the pump 264 is used to increase a pressure of the stripping gas flowing to the circulation gas flowpath 206. For example, in such applications, the pump 264 lifts the pressure of the stripping gas flowing to the circulation gas flowpath 206 enough to enter the system. In exemplary embodiments, the pump 264 may be a diaphragm, a piston, a scroll, or other pumping mechanism that could be gear, cam, or electrically driven.

In a second exemplary embodiment, the arrangement includes an eductor downstream of the accessory gearbox 258 and upstream of the variable flow valve 262. Such a configuration may be used in medium pressure applications, and the eductor is used to pump the stripping gas to the circulation gas flowpath 206.

Referring to FIG. 3, in a third exemplary embodiment, the arrangement includes an orifice 266 that is used in a pure pressure driven system. Such a configuration may be used in higher pressure applications. For example, if the accessory gearbox pressure is greater than the low side gas boost pressure, e.g., with a high enough accessory gearbox pressure, the system is passive, and the stripping gas is driven to the circulation gas flowpath 206 by this high pressure. In such an embodiment, no pump is needed to increase the pressure of the stripping gas flowing to the circulation gas flowpath 206.

Referring to FIGS. 2 and 3, in an exemplary embodiment, the makeup or stripping gas source 260 includes a separator 268 downstream of the stripping gas source 260. The separator 268 is positioned and configured downstream of the intake from the accessory gearbox 260 to prevent oil from getting into the fuel oxygen reduction unit 200. The separator 268 of the present disclosure may comprise a filtering mechanism, filter, splash guard mechanism, air/oil separator, or other separating mechanism that prevents oil from getting into the fuel oxygen reduction unit 200.

As described above, the exemplary fuel oxygen reduction unit 200 defines a circulation gas flowpath 206 extending from the separator 204 to the contactor 202. In one exemplary embodiment, an isolation valve 240 is in airflow communication with the circulation gas flowpath 206 for modulating a gas flow through the circulation gas flowpath 206 to the contactor 202, or rather a flow of stripping gas 220. In certain exemplary embodiments, the circulation gas flowpath 206 may be formed of any combination of one or more conduits, tubes, pipes, etc., as well as structures of components within the circulation gas flowpath 206. In exemplary embodiments, the isolation value may be configured as a shutoff valve or a diverter valve.

For example, referring to FIGS. 2 and 3, in an exemplary embodiment, the isolation valve is configured as a diverter valve. More specifically, the fuel oxygen reduction unit 200 further defines a bypass gas flowpath 244 in fluid communication with the circulation gas flowpath 206 for bypassing the contactor 202 and the fuel gas separator 204 during certain operations. More specifically, the exemplary bypass gas flowpath 244 is in fluid communication with the circulation gas flowpath 206 at a first location 246 positioned upstream of the contactor 202 and a second location 248 positioned downstream of the fuel gas separator 204. More specifically, for the embodiment depicted, the first location 246 is further positioned downstream of the gas boost pump 208 (i.e., between the gas boost pump 208 and the contactor 202) and the second location 248 is positioned upstream of the catalyst 210 and pre-heater 212 (i.e., between the catalyst 210 and the fuel gas separator 204).

Referring to FIGS. 2 and 3, in an exemplary embodiment, the isolation valve system 240 includes a first diverter valve 270 positioned at the first location 246, and the fuel oxygen reduction unit 200 further includes a second diverter valve 272 positioned at the second location 248. Notably, however, in other embodiments, the fuel oxygen reduction unit 200 may only include one diverter valve, with such diverter valve being positioned at the first location 246, or alternatively, the second location 248. It should also be appreciated that the term “diverter valve” simply refers to a valve, or plurality of valves capable of redirecting at least a portion of a fluid flow from a first fluid path to a second fluid path. Accordingly, in certain exemplary embodiments, one or both of the diverter valves 270, 272 may be configured as a variable, three-way fluid valve, as a two-way shut off valve (located downstream of a junction, as a pair of shut off valves, etc.

The exemplary diverter valves 270, 272 depicted are further in fluid communication with the bypass gas flowpath 244 and are configured for selectively diverting the flow of stripping gas 220 through the circulation gas flowpath 206 to the bypass gas flowpath 244, and around the contactor 202 and separator 204. For example, the diverter valves 270, 272 may be configured to divert one hundred percent (100%) of the flow of stripping gas 220 through the circulation gas flowpath 206 to the bypass gas flowpath 244 to substantially completely bypass the contactor 202 and separator 204 during certain operations. However, in other exemplary embodiments, the diverter valves 270, 272 may be configured to divert less than one hundred percent (100%) of the flow of stripping gas 220 through the circulation gas flowpath 206 to the bypass gas flowpath 244 (such as at least ten percent (10%), such as at least twenty percent (20%), such as at least fifty percent (50%), such as up to fifty percent (50%), such as up to seventy-five percent (75%), such as up to ninety percent (90%)).

In an exemplary aspect of the present disclosure, a method is provided for operating a fuel delivery system for a gas turbine engine. The method includes receiving an inlet fuel flow in a fuel oxygen reduction unit for reducing an amount of oxygen in the inlet fuel flow using a stripping gas flow through a stripping gas flowpath; and selectively introducing a stripping gas from a stripping gas source to the stripping gas flowpath, wherein the stripping gas source is an accessory gearbox.

Further aspects of the invention are provided by the subject matter of the following clauses:

1. A fuel oxygen reduction unit for an engine comprising: a fuel oxygen reduction unit defining a stripping gas flowpath and comprising an inlet fuel line and an outlet fuel line, the fuel oxygen reduction unit comprising: an oxygen transfer assembly for reducing an amount of oxygen in an inlet fuel flow through the inlet fuel line using a stripping gas flow through the stripping gas flowpath; and a stripping gas source selectively in fluid communication with the stripping gas flowpath for selectively introducing a stripping gas from the stripping gas source to the stripping gas flowpath, wherein the stripping gas source is an accessory gearbox.

2. The fuel oxygen reduction unit of any preceding clause, wherein the oxygen transfer assembly comprises: a contactor including a fuel inlet that receives the inlet fuel flow and a stripping gas inlet that receives an inlet stripping gas flow from the stripping gas flowpath, the contactor configured to form a fuel/gas mixture; and a separator that receives the fuel/gas mixture, the fuel oxygen reduction unit defining a circulation gas flowpath from the separator to the contactor.

3. The fuel oxygen reduction unit of any preceding clause, further comprising a variable flow valve downstream of the accessory gearbox and upstream of the contactor, wherein the stripping gas from the accessory gearbox is in airflow communication with the circulation gas flowpath via the variable flow valve.

4. The fuel oxygen reduction unit of any preceding clause, wherein the stripping gas comprises accessory gearbox air.

5. The fuel oxygen reduction unit of any preceding clause, further comprising a pump downstream of the accessory gearbox and upstream of the variable flow valve, wherein the pump increases a pressure of the stripping gas flowing to the circulation gas flowpath.

6. The fuel oxygen reduction unit of any preceding clause, further comprising an eductor downstream of the accessory gearbox and upstream of the variable flow valve, wherein the eductor pumps the stripping gas to the circulation gas flowpath.

7. The fuel oxygen reduction unit of any preceding clause, further comprising an air/oil separator downstream of the stripping gas source.

8. The fuel oxygen reduction unit of any preceding clause, further comprising an isolation valve in airflow communication with the circulation gas flowpath for modulating a gas flow through the circulation gas flowpath to the contactor.

9. The fuel oxygen reduction unit of any preceding clause, wherein the stripping gas flows to the circulation gas flowpath downstream of the separator and upstream of the contactor.

10. The fuel oxygen reduction unit of any preceding clause, wherein the separator includes an inlet in fluid communication with the contactor that receives the fuel/gas mixture, a fuel outlet, and a stripping gas outlet, wherein the separator is configured to separate the fuel/gas mixture into an outlet stripping gas flow and an outlet fuel flow and provide the outlet stripping gas flow to the stripping gas outlet and the outlet fuel flow to the fuel outlet.

11. The fuel oxygen reduction unit of any preceding clause, further comprising a catalyst disposed downstream of the separator, the catalyst receives and treats the outlet stripping gas flow, wherein the inlet stripping gas flow exits the catalyst; and a gas boost pump downstream of the separator, wherein the gas boost pump increases a pressure of the inlet stripping gas flow to the contactor.

12. A fuel oxygen reduction unit for an engine comprising: a contactor; a separator, the fuel oxygen reduction unit defining a circulation gas flowpath from the separator to the contactor; and a stripping gas source selectively in fluid communication with the circulation gas flowpath for selectively introducing a stripping gas from the stripping gas source to the circulation gas flowpath, wherein the stripping gas comprises accessory gearbox air.

13. The fuel oxygen reduction unit of any preceding clause, further comprising a variable flow valve downstream of the stripping gas source and upstream of the contactor, wherein the stripping gas from the stripping gas source is in airflow communication with the circulation gas flowpath via the variable flow valve.

14. The fuel oxygen reduction unit of any preceding clause, wherein the stripping gas source is an accessory gearbox, and wherein the stripping gas flows to the circulation gas flowpath downstream of the separator and upstream of the contactor.

15. The fuel oxygen reduction unit of any preceding clause, further comprising a pump downstream of the stripping gas source and upstream of the variable flow valve, wherein the pump increases a pressure of the stripping gas flowing to the circulation gas flowpath.

16. The fuel oxygen reduction unit of any preceding clause, further comprising an eductor downstream of the stripping gas source and upstream of the variable flow valve, wherein the eductor pumps the stripping gas to the circulation gas flowpath.

17. The fuel oxygen reduction unit of any preceding clause, further comprising an air/oil separator downstream of the stripping gas source.

18. The fuel oxygen reduction unit of any preceding clause, further comprising an isolation valve in airflow communication with the circulation gas flowpath for modulating a gas flow through the circulation gas flowpath to the contactor.

19. The fuel oxygen reduction unit of any preceding clause, wherein the contactor includes a fuel inlet that receives an inlet fuel flow and a stripping gas inlet that receives an inlet stripping gas flow, the contactor configured to form a fuel/gas mixture.

20. The fuel oxygen reduction unit of any preceding clause, wherein the separator receives the fuel/gas mixture and includes an inlet in fluid communication with the contactor that receives the fuel/gas mixture, a fuel outlet, and a stripping gas outlet, wherein the separator is configured to separate the fuel/gas mixture into an outlet stripping gas flow and an outlet fuel flow and provide the outlet stripping gas flow to the stripping gas outlet and the outlet fuel flow to the fuel outlet.

21. The fuel oxygen reduction unit of any preceding clause, further comprising a catalyst disposed downstream of the separator, the catalyst receives and treats the outlet stripping gas flow, wherein the inlet stripping gas flow exits the catalyst; and a gas boost pump downstream of the separator, wherein the gas boost pump increases a pressure of the inlet stripping gas flow to the contactor.

22. The fuel oxygen reduction unit of any preceding clause, wherein the gas boost pump is electrically coupled to a permanent magnet alternator (PMA).

23. The fuel oxygen reduction unit of any preceding clause, wherein the separator is electrically coupled to a permanent magnet alternator (PMA).

24. The fuel oxygen reduction unit of any preceding clause, wherein the stripping gas comprises accessory gearbox vent air.

25. A method is provided for operating a fuel delivery system for a gas turbine engine. The method includes receiving an inlet fuel flow in a fuel oxygen reduction unit for reducing an amount of oxygen in the inlet fuel flow using a stripping gas flow through a stripping gas flowpath; and selectively introducing a stripping gas from a stripping gas source to the stripping gas flowpath, wherein the stripping gas source is an accessory gearbox.

This written description uses examples to disclose the invention, including the best mode, and also to enable any person skilled in the art to practice the invention, including making and using any devices or systems and performing any incorporated methods. The patentable scope of the invention is defined by the claims, and may include other examples that occur to those skilled in the art. Such other examples are intended to be within the scope of the claims if they include structural elements that do not differ from the literal language of the claims, or if they include equivalent structural elements with insubstantial differences from the literal languages of the claims.

While this disclosure has been described as having exemplary designs, the present disclosure can be further modified within the spirit and scope of this disclosure. This application is therefore intended to cover any variations, uses, or adaptations of the disclosure using its general principles. Further, this application is intended to cover such departures from the present disclosure as come within known or customary practice in the art to which this disclosure pertains and which fall within the limits of the appended claims.

What is claimed is:

1. A fuel oxygen reduction unit for an engine comprising:
a fuel oxygen reduction unit defining a stripping gas flowpath and comprising an inlet fuel line and an outlet fuel line, the fuel oxygen reduction unit comprising:
an oxygen transfer assembly for reducing an amount of oxygen in an inlet fuel flow through the inlet fuel line using a stripping gas flow through the stripping gas flowpath; and
a stripping gas source selectively in fluid communication with the stripping gas flowpath for selectively introducing a stripping gas from the stripping gas source to the stripping gas flowpath, wherein the stripping gas source is an accessory gearbox.

2. The fuel oxygen reduction unit of claim 1, wherein the oxygen transfer assembly comprises:
a contactor including a fuel inlet that receives the inlet fuel flow and a stripping gas inlet that receives an inlet stripping gas flow from the stripping gas flowpath, the contactor configured to form a fuel/gas mixture; and
a separator that receives the fuel/gas mixture, the fuel oxygen reduction unit defining a circulation gas flowpath from the separator to the contactor.

3. The fuel oxygen reduction unit of claim 2, further comprising:
a variable flow valve downstream of the accessory gearbox and upstream of the contactor, wherein the stripping gas from the accessory gearbox is in airflow communication with the circulation gas flowpath via the variable flow valve.

4. The fuel oxygen reduction unit of claim 3, wherein the stripping gas comprises accessory gearbox air.

5. The fuel oxygen reduction unit of claim 3, further comprising:
a pump downstream of the accessory gearbox and upstream of the variable flow valve, wherein the pump increases a pressure of the stripping gas flowing to the circulation gas flowpath.

6. The fuel oxygen reduction unit of claim 3, further comprising:
an eductor downstream of the accessory gearbox and upstream of the variable flow valve, wherein the eductor pumps the stripping gas to the circulation gas flowpath.

7. The fuel oxygen reduction unit of claim 3, further comprising:
an air/oil separator downstream of the stripping gas source.

8. The fuel oxygen reduction unit of claim 3, further comprising:
an isolation valve in airflow communication with the circulation gas flowpath for modulating a gas flow through the circulation gas flowpath to the contactor.

9. The fuel oxygen reduction unit of claim 3, wherein the stripping gas flows to the circulation gas flowpath downstream of the separator and upstream of the contactor.

10. The fuel oxygen reduction unit of claim 3, wherein the separator includes an inlet in fluid communication with the contactor that receives the fuel/gas mixture, a fuel outlet, and a stripping gas outlet, wherein the separator is configured to separate the fuel/gas mixture into an outlet stripping gas flow and an outlet fuel flow and provide the outlet stripping gas flow to the stripping gas outlet and the outlet fuel flow to the fuel outlet.

11. The fuel oxygen reduction unit of claim 10, further comprising:
a catalyst disposed downstream of the separator, the catalyst receives and treats the outlet stripping gas flow, wherein the inlet stripping gas flow exits the catalyst; and
a gas boost pump downstream of the separator, wherein the gas boost pump increases a pressure of the inlet stripping gas flow to the contactor.

12. A fuel oxygen reduction unit for an engine comprising:
a contactor;
a separator, the fuel oxygen reduction unit defining a circulation gas flowpath from the separator to the contactor; and
a stripping gas source selectively in fluid communication with the circulation gas flowpath for selectively introducing a stripping gas from the stripping gas source to the circulation gas flowpath, wherein the stripping gas comprises accessory gearbox air.

13. The fuel oxygen reduction unit of claim 12, further comprising:
a variable flow valve downstream of the stripping gas source and upstream of the contactor, wherein the stripping gas from the stripping gas source is in airflow communication with the circulation gas flowpath via the variable flow valve.

14. The fuel oxygen reduction unit of claim 13, wherein the stripping gas source is an accessory gearbox, and wherein the stripping gas flows to the circulation gas flowpath downstream of the separator and upstream of the contactor.

15. The fuel oxygen reduction unit of claim 13, further comprising:
a pump downstream of the stripping gas source and upstream of the variable flow valve, wherein the pump increases a pressure of the stripping gas flowing to the circulation gas flowpath.

16. The fuel oxygen reduction unit of claim 13, further comprising:
an eductor downstream of the stripping gas source and upstream of the variable flow valve, wherein the eductor pumps the stripping gas to the circulation gas flowpath.

17. The fuel oxygen reduction unit of claim 13, further comprising:
an air/oil separator downstream of the stripping gas source.

18. The fuel oxygen reduction unit of claim 13, further comprising:
an isolation valve in airflow communication with the circulation gas flowpath for modulating a gas flow through the circulation gas flowpath to the contactor.

19. The fuel oxygen reduction unit of claim 13, wherein the contactor includes a fuel inlet that receives an inlet fuel flow and a stripping gas inlet that receives an inlet stripping gas flow, the contactor configured to form a fuel/gas mixture.

20. The fuel oxygen reduction unit of claim 19, wherein the separator receives the fuel/gas mixture and includes an inlet in fluid communication with the contactor that receives the fuel/gas mixture, a fuel outlet, and a stripping gas outlet, wherein the separator is configured to separate the fuel/gas mixture into an outlet stripping gas flow and an outlet fuel flow and provide the outlet stripping gas flow to the stripping gas outlet and the outlet fuel flow to the fuel outlet.

21. The fuel oxygen reduction unit of claim 20, further comprising:
a catalyst disposed downstream of the separator, the catalyst receives and treats the outlet stripping gas flow, wherein the inlet stripping gas flow exits the catalyst; and
a gas boost pump downstream of the separator, wherein the gas boost pump increases a pressure of the inlet stripping gas flow to the contactor.

22. A method for operating a fuel delivery system for a gas turbine engine comprising:
receiving an inlet fuel flow in a fuel oxygen reduction unit for reducing an amount of oxygen in the inlet fuel flow using a stripping gas flow through a stripping gas flowpath; and
selectively introducing a stripping gas from a stripping gas source to the stripping gas flowpath, wherein the stripping gas source is an accessory gearbox.
